(19) United States
(12) Patent Application Publication
(10) Pub. No.: US 2005/0242564 A1
(43) Pub. Date: Nov. 3, 2005

(54) Multirole notebook

(76) Inventor: Young-Yong Eom, Euijeongbu (KR)

Correspondence Address: SUGHRUE MION, PLLC, 2100 PENNSYLVANIA AVENUE, N.W., SUITE 800, WASHINGTON, DC, 20037, US

(21) Appl. No.: 10/525,667

(22) PCT Filed: Oct. 30, 2002
(86) PCT No.: PCT/KR02/02024

§ 371 Date: Feb. 25, 2005

(30) Foreign Application Priority Data
Aug. 28, 2002 (KR) 200251094

(51) Int. Cl. B42D 1/00

(52) U.S. Cl. 281/15.1

(57) ABSTRACT

A multifunctional notebook is provided. The multifunctional notebook includes a cover and at least one sheet of inner paper. The cover which is composed of a front cover and a back cover, and the at least one sheet of inner paper includes a plurality of recording sheets defined by folding the sheet of inner paper in accordion style so that adjacent folded edges of the inner paper face opposite directions and is fixed to a predetermined part of the inner surface of the cover. The multifunctional notebook can overcome limitations of a conventional folding notebook, organize data in a more visualized manner so that users can identify the data at a glance, and successfully meet users' demands by providing a variety of functions.

### TECHNICAL FIELD

The present invention relates to a multifunctional notebook, and more particularly, to a multifunctional notebook that can overcome limitations of a conventional folding notebook, organize data in a more visualized manner so that users can identify the data at a glance, and successfully meet users' demands by providing a variety of functions.

### BACKGROUND ART

FIG. 1 is a perspective view of a conventional folding notebook. As shown in FIG. 1, the conventional folding notebook includes a cover 10, which is composed of a front cover 11 and a back cover 12. Sheets of inner paper 20, including a plurality of recording sheets 21, are bound together with the cover 10 in the form of a notebook. The conventional folding notebook shown in FIG. 1 is generally used by students to record assignments or take notes.

The conventional folding notebook, however, has several disadvantages. First, since the recording sheets 21 themselves are separated from one another while being bound together with the cover 10 into a notebook, data written on each of the recording sheets 21 can be perceived as being visually separate. Therefore, in a case where a plurality of data dealing with the same content or closely related to each other are written on different pages of the conventional folding notebook, a viewer may have difficulty visually organizing the data so that the data cannot be successfully perceived at a glance.

Second, there is a clear limit in the amount of data that can be recorded on each of the recording sheets 21 especially when the conventional folding notebook is one that is handy to carry around. Therefore, in order to record data beyond the limit, the size of the recording sheets 21 should be enlarged, thereby resulting in a notebook that is less convenient to carry.

Third, the conventional folding notebook cannot meet users' various demands, such as a demand for making a separate file using part of the recording sheets 21.

### DISCLOSURE OF THE INVENTION

The present invention provides a multifunctional notebook which can visually organize data so that the data can be successfully perceived at a glance and can meet users' various demands by providing a variety of functions.

According to an aspect of the present invention, there is provided a multifunctional notebook. The multifunctional notebook includes a cover which is composed of a front cover and a back cover, and at least one sheet of inner paper which includes a plurality of recording sheets defined by folding the sheet of inner paper in an accordion style so that adjacent folded edges of the inner paper face opposite directions and is fixed to a predetermined part of the inner surface of the cover.

Preferably, the plurality of recording sheets are horizontally connected to one another.

Preferably, the plurality of recording sheets are vertically connected to one another.

Preferably, a perforated line is formed on each of the folded edges of the inner paper so that the plurality of recording sheets can be torn apart from one another.

Preferably, at least one title section, which is used for classifying predetermined data, and an information section, in which the predetermined data is recorded, are provided in a direction perpendicular to a direction along which the plurality of recording sheets are connected to one another.

Preferably, each of the plurality of recording sheets has an index means at one side.

Preferably, the index means is as many perforated hole patterns as there are recording sheets are provided, and the perforated hole patterns are regularly distanced from each other.

Preferably, a perforated line is formed on the plurality of recording sheets so that each of the plurality of recording sheets can be divided into two or more parts along a direction along which the plurality of recording sheets are connected to one another.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional folding notebook;

FIGS. 2 and 3 are perspective views of multifunctional notebooks according to a first embodiment of the present invention;

FIG. 4 is a perspective view of a file made by using some of the recording sheets shown in FIGS. 2 and 3;

FIG. 5 is a perspective view illustrating a method of using the multifunctional notebook of FIG. 2 or 3;

FIG. 6 is a perspective view of a multifunctional notebook according to a second embodiment of the present invention; and

FIG. 7 is a perspective view of a multifunctional notebook according to a third embodiment of the present invention.

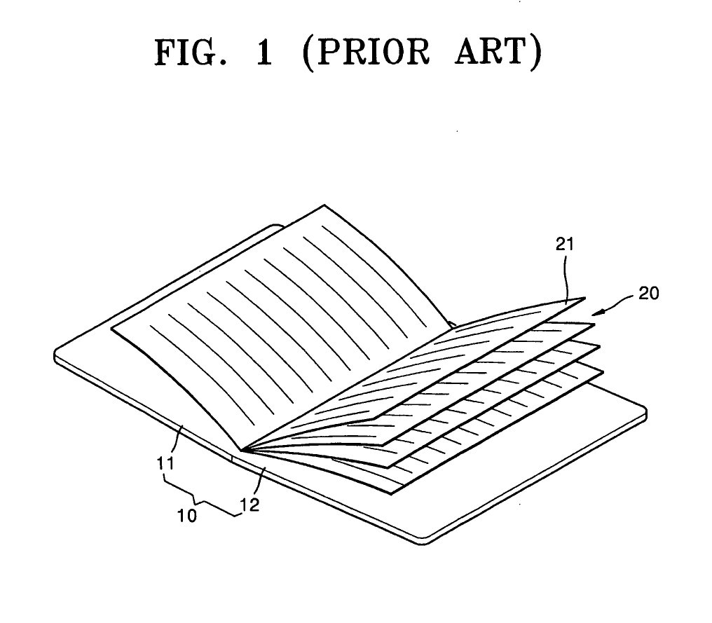

### BEST MODES FOR CARRYING OUT THE INVENTION

Hereinafter, the present invention will be described in greater detail with reference to the accompanying drawings in which preferred embodiments of the invention are shown.

### EMBODIMENT 1

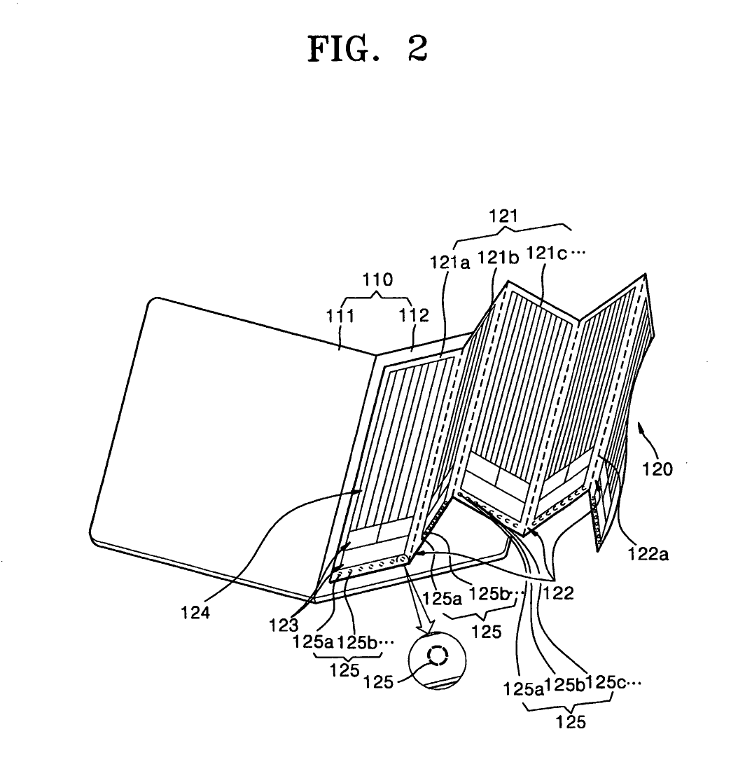

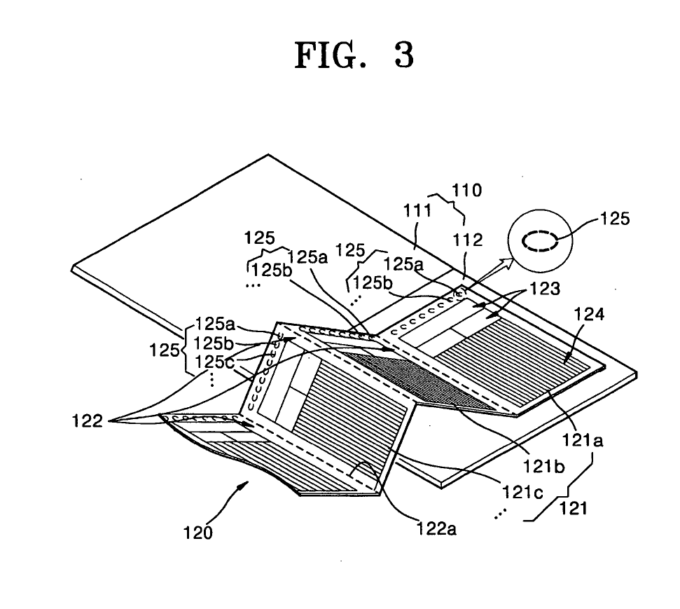

FIGS. 2 and 3 are perspective views of multifunctional notebooks according to a first embodiment of the present invention. More specifically, FIG. 2 illustrates a multifunctional notebook in which recording sheets are horizontally connected to each other, and FIG. 3 illustrates a multifunctional notebook in which recording sheets are vertically connected to each other.

Each of the multifunctional notebooks, shown in FIGS. 2 and 3, includes a cover 110 composed of a front cover 111 and a back cover 112, and a sheet of inner paper 120, which is fixed to an inner side of the cover 110 near the interface between the front cover 111 and the back cover 112. Although FIGS. 2 and 3 illustrate the multifunctional notebooks as including only one sheet of inner paper 120, the multifunctional notebooks according to the present invention may include more than one sheet of inner paper 120 fixed to the cover 110.

The sheet of inner paper 120 includes a plurality of recording sheets 121, which are defined by folding the inner paper 120 back and forth in an accordion style so that adjacent folded edges 122 of the sheet of inner paper 120 face opposite directions.

The plurality of recording sheets 121 can be horizontally connected to each other, as shown in FIG. 2. Alternatively, the plurality of recording sheets 121 can be vertically connected to each other, as shown in FIG. 3.

A perforated line 122a is formed along each of the folded edges of the sheet of inner paper 120 so that a user can tear apart the recording sheets 121 from one another by tearing the sheet of inner sheet 120 along the perforated line 122a.

On each of the recording sheets 121, at least one title section 123, which is used for identifying the subject of predetermined data written on the corresponding recording sheet, and an information section 124, in which the predetermined data will be recorded, are arranged along a direction perpendicular to the length of the sheet of inner paper 120. Since the title section 123 and the information section 124 are provided on each of the recording sheets 121, a user can record data on the recording sheets 121 in a more organized manner. Even though FIGS. 2 and 3 illustrate two title sections as being provided onto each of the recording sheets 121, the number of title sections that can be provided onto each of the recording sheets 121 can vary depending on the desired functions of a multifunctional notebook.

Preferably, an index means is provided at one side of the recording sheets 121 so that the recording sheets 121 can be easily identified.

The index means can be formed using a plurality of perforated hole patterns 125, which are provided on each of the recording sheets 121 and are regularly distanced from one another. As many perforated hole patterns 125 as there are recording sheets 121 can be provided to each of the recording sheets 121. Therefore, a user can selectively remove a predetermined number of perforated hole patterns 125.

More specifically, the user can remove a first perforated hole pattern 125a of a first recording sheet 121a, remove first and second perforated hole patterns 125a and 125b of a second recording sheet 121b, and remove first, second and third perforated hole patterns 125a, 125b and 125c of a third recording sheet 121c. Namely, the user can remove as many perforated patterns as a sequence number of each of the recording sheets 121 from each of the recording sheets 121. Then, each of the recording sheets 121 can be identified based on how many perforated holes it includes.

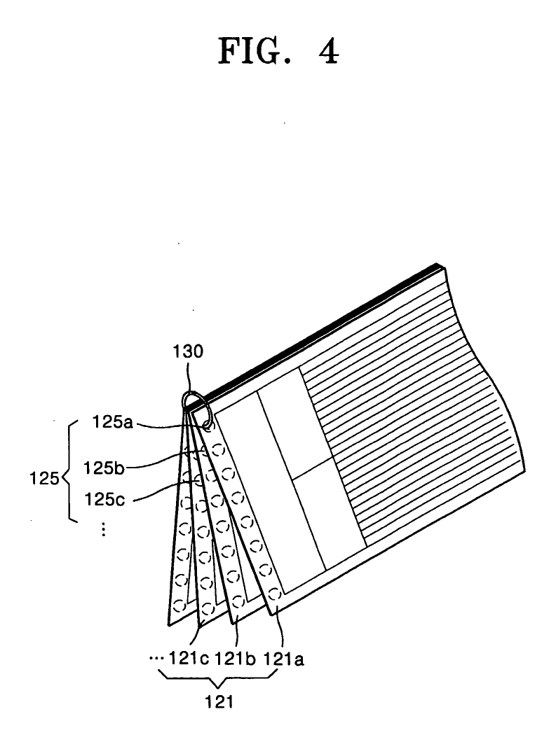

As shown in FIG. 4, in the case of making some of the recording sheets 121 into a separate file, the recording sheets 121 can be bound together by passing a binding means 130 through a first perforated hole of each of the recording sheets 121.

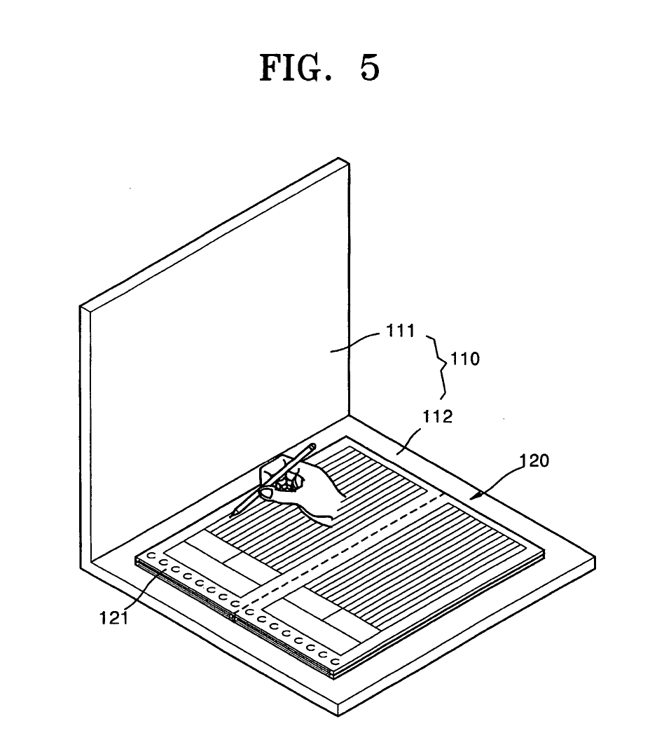

In the first embodiment of the present invention, a user can record data on each of the recording sheets 121 in the same manner as he/she does in a typical folding notebook, as shown in FIG. 5. The data recorded on the recording sheets 121 of the multifunctional notebook according to the first embodiment of the present invention can be more easily perceived at a glance by simply unfolding the recording sheets 121.

### EMBODIMENT 2

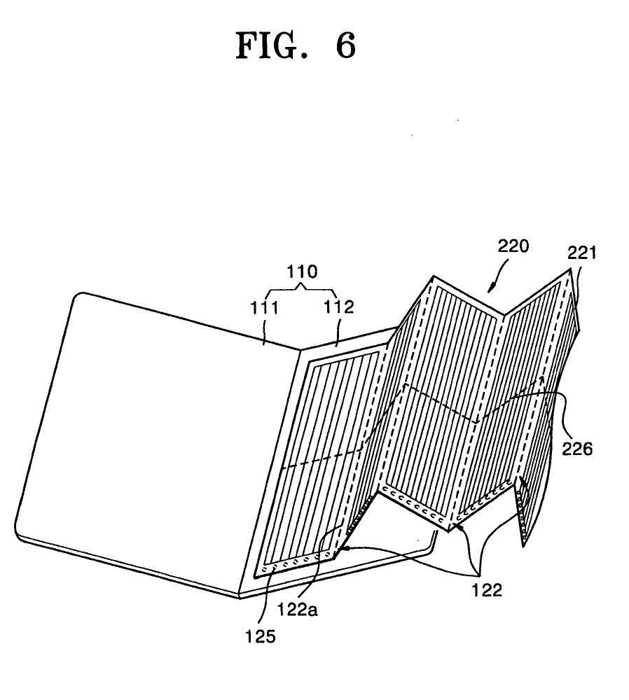

FIG. 6 is a perspective view of a multifunctional notebook according to a second embodiment of the present invention. The same reference numerals in FIGS. 2, 3, and 6 represent the same elements, and thus their description will not be repeated here.

As described in FIG. 6, the multifunctional notebook includes a sheet of inner paper 220, which can be torn apart into a plurality of recording sheets 221. A perforated line 226 is formed along the direction of the length of the sheet of inner paper 220 so that each of the recording sheets 221 can be torn apart into two identical parts along the perforated line 226. For example, let us assume that a user records English words on the left part of each of the recording sheets 221 and records meanings of those English words in Korean on the right part of each of the recording sheets 221. In this case, the user can selectively tear off the left or right part of the recording sheets 221 along the perforated line 226.

FIG. 6 illustrates the recording sheets 221 as being horizontally connected to one another. However, even if they are vertically connected to one another, the recording sheets 221 can successfully meet the requirements of the multifunctional notebook according to the second embodiment of the present invention.

### EMBODIMENT 3

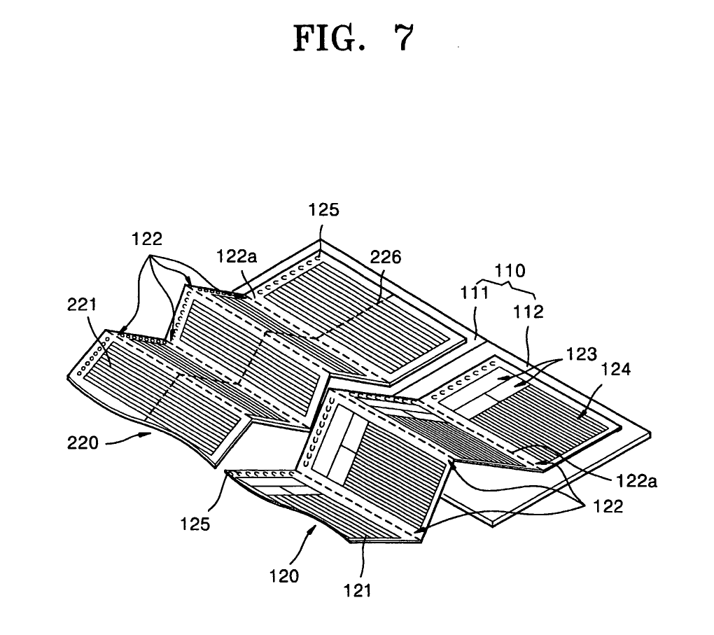

FIG. 7 is a perspective view of a multifunctional notebook according to a third embodiment of the present invention. The same reference numerals in FIGS. 2, 3 and 7 represent the same elements, and thus their description will not be repeated here.

As shown in FIG. 7, the multifunctional notebook includes a plurality of sheets of inner paper 120 and 220. The plurality of sheets of inner paper 120 and 220 include pluralities of recording sheets 121 and 221, respectively. On each of the recording sheets 121 included in at least the sheet of inner paper 120, at least one title section 123, which is used for identifying the subject of predetermined data recorded on the corresponding recording sheet, and an information section 124, in which the predetermined data is recorded, are arranged along a direction perpendicular to the length of the sheet of inner paper 120. The recording sheets 121 are connected to one another along the direction of the length of the inner paper 120. On the recording sheets 221 included in at least the sheet of inner paper 220, a perforated line 226 is formed along the direction of the length of the sheet of inner paper 220.

FIG. 7 illustrates each of the plurality of recording sheets 121 or 221 as being vertically connected to one another. However, even if they are horizontally connected to one another, the recording sheets 121 or 221 can successfully meet the requirements of the multifunctional notebook according to the third embodiment of the present invention.

### INDUSTRIAL APPLICABILITY

The multifunctional notebook according to the present invention provides several advantages. First, since recording sheets are connected to one another, it is possible to identify data recorded on different recording sheets at a glance. Therefore, it is possible to organize data on the recording sheets in a more visualized way.

Second, since small-sized recording sheets, connected to one another, are bound together into a notebook, it is possible for a user to easily carry the notebook and record a considerable amount of data in the notebook.

Third, each plurality of recording sheets of the multifunctional notebook or part of each of the plurality of recording sheets of the multifunctional notebook can be made into an independent file. In addition, each of the recording sheets can be separated into title sections and information sections so that data recorded on the corresponding recording sheet can be more efficiently organized. Therefore, it is possible to meet users' demands by providing a variety of functions.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multifunctional notebook comprising:
a cover which is composed of a front cover and a back cover; and
at least one sheet of inner paper which includes a plurality of recording sheets defined by folding the sheet of inner paper in an accordion style so that adjacent folded edges of the inner paper face opposite directions and is fixed to a predetermined part of the inner surface of the cover,
wherein at least one title section, which is used for classifying predetermined data, and an information section, in which the predetermined data is recorded, are provided in a direction perpendicular to a direction along which the plurality of recording sheets are connected to one another.

2. The multifunctional notebook of claim 1, wherein the plurality of recording sheets are horizontally connected to one another.

3. The multifunctional notebook of claim 1, wherein the plurality of recording sheets are vertically connected to one another.

4. (canceled)

5. (canceled)

6. The multifunctional notebook of claim 1, wherein each of the plurality of recording sheets has an index means at one side.

7. The multifunctional notebook of claim 6, wherein the index means is as many perforated hole patterns as there are recording sheets are provided, and the perforated hole patterns are regularly distanced from each other.

8. The multifunctional notebook of claim 1, wherein a perforated line is formed on the plurality of recording sheets so that each of the plurality of recording sheets can be divided into two or more parts along a direction along which the plurality of recording sheets are connected to one another.
